(19) United States
(12) Patent Application Publication
(10) Pub. No.: US 2006/0060611 A1
(43) Pub. Date: Mar. 23, 2006

(54) Metering pump, nozzle holder and system for the direct metering

(76) Inventor: Wolf-Dieter Wichmann, Neetzow (DE)

Correspondence Address: FLYNN THIEL BOUTELL & TANIS, P.C., 2026 RAMBLING ROAD, KALAMAZOO, MI, 49008-1631, US

(21) Appl. No.: 11/233,086

(22) Filed: Sep. 22, 2005

Related U.S. Application Data
(60) Provisional application No. 60/612,340, filed on Sep. 23, 2004.

(51) Int. Cl. B67D 5/40

(52) U.S. Cl. 222/383.1

(57) ABSTRACT

A metering pump for the direct metering of active compounds, in particular for agricultural technology, includes having at least one housing with a delivery space, a reciprocating element, which bounds the delivery space at least on one side and is arranged movably in the housing, at least one suction valve connected in terms of flow to the delivery space, and at least one outlet valve connected in terms of flow to the delivery space. The reciprocating element is designed as a piston which can be displaced between two end positions, and an elastic ring is provided between housing and piston, which ring is at least partially compressed in both end positions of the piston.

### CROSS-REFERENCE TO RELATED APPLICATIONS

This application claims the benefit of U.S. Provisional Application Ser. No. 60/612,340, filed Sep. 23, 2004, which is incorporated herein in its entirety.

### FIELD OF THE INVENTION

The invention relates to a metering pump for the direct metering of active compounds, in particular for agricultural technology, having at least one housing with a delivery space, a reciprocating element, which bounds the delivery space at least on one side and is arranged movably in the housing, at least one suction valve connected in terms of flow to the delivery space, and at least one outlet valve connected in terms of flow to the delivery space. The invention also relates to a nozzle holder for agricultural spraying devices, and to a system for the direct metering, in each case with a metering pump according to the invention.

### BACKGROUND OF THE INVENTION

International patent publication WO 96/35876 discloses a metering pump with a suction valve and an outlet valve, in which a delivery space is bounded on the one hand by a housing and on the other hand by a flexible diaphragm. The deflection of the diaphragm takes place hydraulically. The extreme positions of the diaphragm are defined by the fact that the latter then bears in each case against a housing-side boundary of a delivery space or of a pressure space. The problem with diaphragm pumps is the diaphragm material which firstly has to withstand a multiplicity of strokes of the pump and secondly, when pumping aggressive media, has to be manufactured from extremely resistant material.

### SUMMARY OF THE INVENTION

The invention is to be used to provide a metering pump for the direct metering of active compounds, which is highly reliable and highly precise yet has a simple construction.

For this purpose, the invention provides a metering pump for the direct metering of active compounds, in particular for agricultural technology, having at least one housing with a delivery space, a reciprocating element, which bounds the delivery space at least on one side and is arranged movably in the housing, at least one suction valve connected in terms of flow to the delivery space, and at least one outlet valve connected in terms of flow to the delivery space, in which the reciprocating element is designed as a piston which can be displaced between two end positions, and an elastic ring is provided between housing and piston, which ring is at least partially compressed in both end positions of the piston.

By a piston being used as a reciprocating element which is displaceable between two end positions, a high precision of the metering pump is firstly ensured, since the piston always displaces the same volume between the two end positions. In contrast to a diaphragm, a piston can be manufactured comparatively favorably in terms of cost from material which withstands even the most aggressive media, since the piston does not itself have to be of elastic design. A sealing of the piston with respect to a housing and a resetting of the piston into one of its end positions can take place by means of an elastic ring, the elastic ring preferably being a standard component. Elastic rings, for example of elastomeric material, and especially what are referred to as O-rings, are obtainable in a very wide variety of sizes, elasticities and, inter alia, made of chemically extremely resistant materials. The elastic ring preferably has a circular cross section. Elastic rings with a circular cross section are firstly easily obtainable as a standard component and secondly, by provision of a circular ring, a desired prestressing characteristic is achieved, since the piston is braked gradually as far as its end position by means of the elastic ring. Since the elastic ring is at least partially compressed or prestressed in both end positions of the piston, a reliable sealing of the piston is obtained.

In a development of the invention, each of the two end positions of the piston is defined by a particular stop surface of the piston bearing against the housing.

By means of this measure, a working stroke of the piston can be exactly defined irrespective of the elasticity of the elastic ring, so that, per stroke, the metering pump displaces or sucks up a volume which is always exactly the same. This makes it possible to define a metering amount in pulses and, as a result, to provide a dimensional quantity which can easily be processed by electric controllers.

In a development of the invention, the elastic ring is arranged between a peripheral surface on the piston arranged essentially perpendicular to a direction of movement of the piston and a peripheral surface on the housing arranged essentially perpendicular to the direction of movement of the piston, the elastic ring being prestressed in both end positions of the piston and bringing about a seal between delivery space and piston.

The peripheral surfaces for the elastic ring to bear against are, for example, designed in each case as peripheral shoulders, so that the piston and the bearing surface can be formed on the housing by turning processes. By the elastic ring being prestressed in both end positions of the piston, the piston is firstly reliably also held in its inoperative position, corresponding to a first end position, and, in addition, at the same time a sealing of the delivery space can take place by means of the elastic ring. The elastic ring therefore fulfills a dual function. In this manner, a simple construction of the metering pump with only a few components can be achieved. The elastic ring is preferably also prestressed by approximately 20% of its maximum compressibility in the inoperative position of the piston.

In a development of the invention, the housing has an adjustable stop in order to variably limit a working stroke of the piston.

For example, a threaded bolt which projects into the delivery space or into a pressure space lying opposite the delivery space is provided as the stop. By means of an adjustable stop, a working stroke of the metering pump and therefore the volume sucked up and ejected can be set, for example in order to calibrate the displacement volume of the metering pump to a predetermined value.

In a development of the invention, means for switching over a delivery direction are provided.

For example, a connection which can be switched over can be provided between suction valve and suction pipe and between outlet valve and outlet pipe, so that the suction valve is optionally connectable to the suction pipe or to the outlet pipe and the outlet valve is optionally connectable to the outlet pipe or the suction pipe. The metering pump according to the invention can thereby be used flexibly, since the delivery direction can be reversed in a simple manner.

In a development of the invention, the suction valve and the outlet valve are arranged in a common valve block, the valve block being arranged rotatably relative to the housing of the metering pump.

By means of this measure, a reversal of the delivery direction can be obtained by simple rotation of the valve block. For this purpose, an inlet opening for the suction valve and the outlet valve and the corresponding through-openings into the working space of the metering pump have to be arranged concentrically about an axis of rotation of the valve block. Sealing can take place, for example, by means of O-rings arranged in the rotational surface. For example, the suction valve and the outlet valve can be arranged in a roller-like body which is arranged rotatably about its longitudinal axis in a matching bore in the housing.

In a development of the invention, a flange component with the suction pipe and the outlet pipe is provided, the outlet valve and the suction valve being arranged rotatably relative to the flange component.

The flange component and the housing of the metering pump are expediently immovable relative to each other and, for example, are in a single piece. The valve block with the outlet valve and the suction valve is then arranged rotatably with respect to the housing and with respect to the flange component.

In a development of the invention, the at least one suction valve and/or the at least one outlet valve in each case have an elastic diaphragm as shut-off element.

By means of diaphragm valves, a cost-effective, simple construction of high precision and high resistance even in the case of aggressive media can be obtained. Especially in the case of diaphragm valves, the risk of clogging is lower, even in the case of aggressive media or media containing suspended solids, than in the case of valves with components sliding on one another. Diaphragm valves also have a very long service life if the diaphragms are appropriately designed.

In a development of the invention, the suction valve and/or the outlet valve have a valve housing with a valve chamber, the valve chamber having an end surface with a passage bore arranged essentially centrally in the end surface, the elastic diaphragm, in the inoperative state, bearing at least in some sections against the end surface and having a central region which covers the passage bore and is connected by means of at least two spoke-like connecting regions to an outer ring of the elastic diaphragm.

The outer ring of the elastic diaphragm is preferably circular, and the diaphragm is produced in a single piece from elastic sheet material. Such a construction according to the invention of the suction valve and/or of the outlet valve results in a valve which forms a reliable seal, even when there are small differences in pressure, or opens up a flow path. The valve housing together with the valve chamber is expediently flange-mounted on the housing of the metering pump.

In a development of the invention, three spoke-like connecting regions which are spaced uniformly from one another in the circumferential direction are provided.

By means of such a configuration of the pump diaphragm, uniform and point-symmetric loadings are obtained in the diaphragm, with the result that a rapid response and reliable sealing even when there are small differences in pressure, and also a long service life are obtained.

In a development of the invention, the suction valve and/or the outlet valve has two diaphragm valves connected in series.

By means of a series connection, an increased security against failure of the valves can be achieved and nevertheless the response behavior is only negligibly affected, if at all.

In a development of the invention, a pressure space which can be charged hydraulically is provided on a side of the piston that faces away from the delivery space.

A hydraulic charging of the piston can firstly take place with high precision and also at high frequencies. In the case of applications in agricultural technology, a hydraulic charging is advantageous, since a sufficient electric power for electric driving of a multiplicity of metering pumps is not generally available on vehicles for agricultural technology, but there are powerful hydraulic systems.

In a development of the invention, a rotary control slide valve is provided for the hydraulic charging of the pressure space.

By means of a rotary control slide valve, high activation frequencies can also be realized without a large driving force being required for driving the rotary control slide valve. This is because a rotary control slide valve switches in neutral and the hydraulic pressure to be switched therefore only has a very small influence on the mechanical resistance during switching. In addition, in contrast to a linear control slide valve, in the case of a rotary control slide valve, no inertial forces of the switching element have to be overcome, and so the driving power required can be kept low. In addition, a restoring force does not have to be overcome either during switching.

In a development of the invention, the rotary control slide valve has a slide valve housing and a slide valve mounted rotatably in the slide valve housing, the slide valve housing being connected in terms of flow to a pressure supply line, a pressure removal line and the pressure space. As a result, by means of a comparatively simple construction, a reliable and precise activating element can be provided. The slide valve housing is preferably flange-mounted onto the housing of the metering pump.

In a development of the invention, the slide valve is of hollow-cylindrical design and at least one control slot is provided in a circumferential wall of the slide valve.

As a result, the size of the control slot can be changed in a simple manner without the basic construction of the slide valve having to be changed. One end side of the slide valve has, for example, a passage opening which then opens into the pressure space of the metering pump. Opposite the passage opening there can be drive shaft which extends out of the slide valve housing and is driven, for example, by an electric stepping motor.

In a development of the invention, at least two displaceably arranged pistons are provided in the housing of the metering pump.

This makes it possible for a pumping volume of the metering pump to be adapted in a flexible manner.

In a development of the invention, at least some of the pistons have a different cross-sectional area.

In this manner, the prerequisites for a variable metering pump pumping volume which can be set within wide limits are provided.

In a development of the invention, the pistons act upon a common working space.

In a development of the invention, means are provided in order to cause a different movement of the pistons.

In this manner, the metering pump pumping volume can be configured variably by, for example, either both pistons pumping or only one of the two pistons being active. For example, separate pressure spaces or pressure spaces which can be separated by means of a shut-off valve can be provided. In addition, it is also possible to mechanically stop a piston by means of an adjustable stop.

In a development of the invention, at least two rotary control slide valves are provided, and at least some of the pistons can be acted upon by different rotary control slide valves.

Also in this manner, a different movement of the pistons can be achieved by the latter be activated separately.

In a development of the invention, at least some of the pistons act upon a separate delivery space.

Each delivery space then preferably has a dedicated suction valve and outlet valve. As a result, despite a common activation of the pistons, a variable stroke can be achieved by, for example, one of the delivery spaces being shut-off if required. In this case, at least some of the pistons can then be acted upon by means of a common rotary control slide valve. In the case of a separate activation of the pistons and separate delivery spaces, a metering pump can be realized with which, for example, two liquids can be reproducibly mixed at a mixing ratio which can be set within wide limits.

The invention also relates to a nozzle holder for agricultural spraying devices with a metering pump according to the invention.

The metering pump according to the invention may be designed to be of such a small size that it can be arranged directly on the nozzle holder or can be integrated into the nozzle holder. The feeding of active compounds directly to the spray nozzles is therefore possible. In the case of metered addition of a plurality of active compounds, a plurality of metering pumps according to the invention can be arranged on each nozzle holder of a field sprayer or can be integrated into them.

The invention also relates to a system for the direct metering of active compounds for agricultural technology with at least one metering pump according to the invention.

The metering pump according to the invention is suitable in a particular manner for a direct metering of active compounds, for example in the case of field sprayers, since it is capable of bringing about a feeding of active compounds even into the water flow, which is already under positive pressure, downstream of a water pump. In field sprayers, there can be, for example, a water pressure of up to 10 bar. The metering pump according to the invention permits a highly precise metering in of active compounds, since, per activation pulse, the precisely identical amount of active compound is always sucked up and ejected again.

According to the invention, a system for the direct metering has at least one metering pump, at least one active compound tank with active compound which is to be metered, a carrier liquid tank and a carrier liquid pump and at least a partial width section with at least one spray nozzle and a partial width section valve for shutting off and opening up a supply of liquid to the partial width section, a first active compound line leading from the active compound tank to the suction connection of the metering pump and a second active compound line opening into a mixing chamber, the partial width section being arranged downstream of the mixing chamber, a carrier liquid line leading from the carrier liquid tank via the carrier liquid pump to the mixing chamber, and a connection being provided between an outlet connection of the metering pump and upstream of the partial width section valve, for introducing compressed air into the second active compound line for a recirculating operation.

By means of these measures, in the case of a direct feeding-in system, a recirculating operation can be realized, in which the active compound present in concentrated form in the active compound lines and the metering pump is pressed back into the active compound tank by compressed air. This is of considerable importance firstly for cost reasons, since the active compounds are very expensive and, in the case of large field sprayers, there can be a considerable volume of concentrated active compound in the active compound lines. Secondly, the active compound lines and the metering pump are already roughly cleaned as a result without flushing mixture, which already is no longer useable and is contaminated with active compound, being obtained by the cleaning. If appropriate, before compressed air is introduced, the delivery direction of the metering pump is turned around, so that the flow can pass through the latter counter to the original delivery direction.

The invention also provides a system for the direct metering with at least one metering pump, at least one active compound tank with active compound which is to be metered, a carrier liquid tank and a carrier liquid pump and at least one partial width section with at least one spray nozzle and a partial width section valve for shutting off and opening up a supply of liquid to the partial width section, a first active compound line leading from the active compound tank to the suction connection of the metering pump and a second active compound line opening into a mixing chamber, the partial width section being arranged downstream of the mixing chamber, a carrier liquid line leading from the carrier liquid tank via the carrier liquid pump to the mixing chamber, and a connection being provided between the outlet connection of the metering pump and upstream of the partial width section valve, for introducing carrier liquid into the second active compound line for a flushing operation.

This makes it possible for the active compound lines and the metering pump to be flushed in a simple manner, with, in contrast to the metering operation, a flushing operation taking place in the opposite direction of flow. For example, for the flushing operation, the delivery direction of the metering pump can then be switched over, with the result that the flow can then pass through the latter in the reverse direction. If, according to the invention, first of all a recirculating operation is set and concentrated active compound is pressed back into the active compound tank by compressed air, in a subsequent flushing operation all that still needs to be done is to flush out the residues of active compound that are adhering to the line walls. The quantity of active compound obtained as a result in the flushing operation is obviously significantly smaller.

In a development of the invention, a disposal container is provided for receiving a mixture of carrier liquid and active compound, in particular from a flushing operation, and during the flushing operation the first active compound line can be switched over from the active compound tank to the flushing container.

In this manner, the quantities of carrier liquid contaminated with active compound that are obtained in the flushing operation do not have to be directly sprayed off, but rather can initially be stored in the disposal container. Since, in comparison to conventional systems for the direct metering, significantly less and less severely contaminated flushing mixture is obtained, this considerably increases the availability of the system according to the invention. For example, the disposal container does not have to be emptied after every flushing operation, and so the system according to the invention for the direct metering can be used significantly more efficiently in comparison to known systems.

### BRIEF DESCRIPTION OF THE DRAWINGS

Further features and advantages of the invention emerge from the description below of preferred embodiments of the invention in conjunction with the drawings. In the drawings:

FIG. 1 shows a sectional view of a first embodiment of a metering pump according to the invention,

FIG. 2 and FIG. 3 show diagrammatic sectional views for clarifying the operation of the metering pump according to the invention,

FIG. 4 and FIG. 5 show sectional views for clarifying the operation of a suction valve of the metering pump from FIG. 1,

FIG. 6 shows an enlarged perspective illustration of a valve diaphragm for the metering pump according to the invention,

FIG. 7 shows a sectional view of a second embodiment of a metering pump according to the invention,

FIG. 8 shows the metering pump from FIG. 7 with the delivery direction reversed,

FIG. 9 shows a diagrammatic illustration of a system according to the invention for the direct metering with the metering pump from FIGS. 7 and 8,

FIG. 10 shows the system for the direct metering from FIG. 9 in a recirculating operation,

FIG. 11 shows the system for the direct metering from FIG. 9 in a flushing operation,

FIG. 12 shows a third embodiment of a metering pump according to the invention,

FIG. 13 shows a fourth embodiment of a metering pump according to the invention,

FIG. 14 shows a nozzle holder for a field sprayer with four metering pumps according to the invention in accordance with a fifth embodiment, and

FIG. 15 shows a sectional view of a valve block for a metering pump according to the invention in accordance with a sixth embodiment.

### DETAILED DESCRIPTION OF THE INVENTION

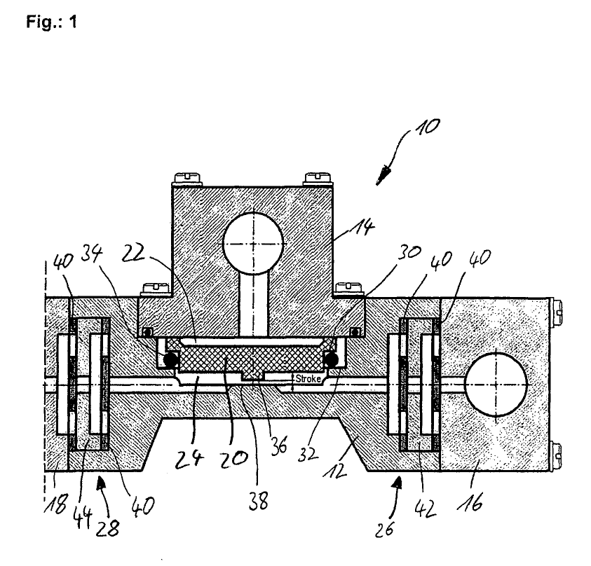

The illustration of fig; 1 shows a sectional view of a metering pump 10 according to the invention. The metering pump 10 has a multipart housing which is constructed from a housing lower part 12, a housing upper part 14, a suction flange 16 and an outlet flange 18 (only partially illustrated). A piston 20 is arranged in a piston space formed between the housing lower part 12 and the housing upper part 14. The piston 20 divides the piston space into a hydraulically chargeable pressure space 22 and a delivery space 24. The delivery space 24 is connected in terms of flow to a suction valve 26 and an outlet valve 28. An elastic ring 34 with a circular cross section is arranged between a peripheral shoulder 30 on the piston 20 and a peripheral shoulder 32 on the housing lower part 12. In the illustrated inoperative position of the piston 20, the elastic ring 34 is clamped between the peripheral shoulder 30 on the piston 20 and the opposite, peripheral shoulder 32 on the housing lower part 12 and, as a result, takes on the sealing off of the delivery space 24 from the piston 20. In addition, the elastic ring 34 prestresses the piston 20 into its inoperative position (illustrated in FIG. 1). As a result, the elastic ring 34 takes on both a sealing function and a prestressing function.

It is otherwise to be stressed that as a result of the fact that the elastic ring 34 takes on the sealing between working space 24 and piston 20, an outer wall of the piston 20 can be at a distance from an inner wall of the piston space, with the result that no friction or only negligible friction arises between piston 20 and inner wall of the piston space.

As can be seen in FIG. 1 and FIGS. 2 and 3, upon hydraulic charging of the pressure space 22, the piston 20 moves downward, in the illustration of FIGS. 1, 2 and 3, in such a manner that a pressure in the pressure space 22 is higher than a counterpressure in the delivery space 24. In this case, the piston 20 moves downward only until a projection 36 provided on the piston 20 strikes against an opposite projection 38 on the housing lower part 12. The projection 36 is arranged on the piston 20 in the center of a surface of the piston 20 facing the delivery space 24. In the illustration of FIG. 1, the projection 38 on the housing lower part 12 is designed such that it is larger in terms of area perpendicular to the direction of movement of the piston 20 than the projection 36 and lies opposite the latter.

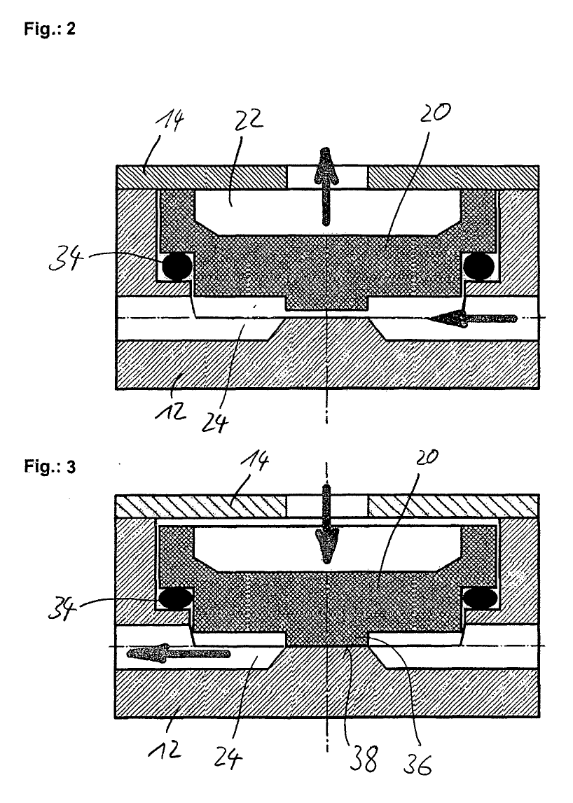

Both end positions of the piston 20 are therefore defined by surfaces of the piston 20 bearing against housing surfaces. Thus, the inoperative position of the piston 20 that is illustrated in FIG. 1 and FIG. 2 is defined by the fact that a peripheral edge of the piston 20 facing away from the delivery space 24 bears against the planar lower side of the housing upper part 14, which side faces the piston space. When the piston is deflected downward in FIG. 1, the corresponding end position is then defined by the projection 36 of the piston 20 bearing against the projection 38 of the housing lower part 12. As a result, a working stroke of the piston 20 is exactly defined irrespective of the elasticity properties of the elastic ring 34. The amount of liquid delivered by the metering pump 10 per piston stroke is therefore also exactly defined and does not change even due to a possible change in the elastic properties of the elastic ring 34. The metering pump 10 is thus particularly suitable for a pulse control, since a required amount of liquid can be exactly defined by the number of hydraulic stroke pulses in the pressure space 22.

The suction valve 26 and the outlet valve 28 are also arranged within the housing of the metering pump 10. Both the suction valve 26 and the outlet valve 28 is constructed here as a diaphragm valve and has in each case two valves which are connected in series and each have a diaphragm 40. All of the diaphragms 40 are of identical construction and can be used both in the suction valve 26 and in the outlet valve 28.

The housing lower part 12 has a cylindrical recess both on the side of the suction valve 26 and on the side of the outlet valve 28, the cylindrical recess on the side of the suction valve 26 being provided with a step at its end facing the delivery space 24. This step forms a peripheral shoulder in the cylindrical recess, and an outer ring of the diaphragm 40 rests on this peripheral shoulder. In the direction away from the delivery space 24, following the first diaphragm 40 on the side of the suction valve 26 is an intermediate part 42 which is U-shaped in cross section and has a central through-opening. A further diaphragm 40 is then clamped between the peripheral edge of this intermediate part 42 and the opposite surface of the suction flange 16. Both diaphragms 40 of the suction valve 26 can therefore move in their central region toward the delivery space 24 and, as a result, open up the central through-opening in the suction flange 16 or in the intermediate part 42.

On the part of the outlet valve 28, a cylindrical recess is likewise provided in the housing lower part 12, with an end surface of this cylindrical recess being of flat design and an outlet channel originating from the delivery space 24 opening out into this end surface. This first diaphragm is then followed, as seen from the delivery space 24, by an intermediate part 44 which is formed identically to the intermediate part 42 on the part of the suction valve 26. In contrast to the intermediate part 42, the intermediate part 44 on the part of the outlet valve 28 is inserted, however, in such a manner that the central region of the first diaphragm 40 can move away from the delivery space. The intermediate part 44 is then followed by a second diaphragm 40 which rests on the planar rear side of the intermediate part 44 and closes the central through-bore situated therein. The second diaphragm 40 is clamped at its edge by means of the outlet flange 18, and the outlet flange 18 has a cylindrical recess in its end surface facing the housing lower part 12, so that the second diaphragm 40 can move away in its central region from the delivery space 24.

In the illustration of FIG. 2 and FIG. 3, the operation of the metering pump 10 is illustrated diagrammatically. According to FIG. 2, when the piston 20 moves upward and therefore enlarges the volume of the delivery space 24, liquid is sucked into the delivery space. This movement of the piston 20 upward is caused by the fact that the pressure in the pressure space 22 is reduced and the prestressing force of the elastic ring 34 can push the piston 20 upward until the peripheral edge of the piston 20 bears against that surface of the housing upper part 14 which bounds the pressure space 22.

If, according to FIG. 3, the pressure space 22 is then charged again with a positive pressure which is of a sufficient size that it overcomes the prestressing force of the elastic ring 34 and the counter pressure in the delivery space 24, liquid is ejected from the delivery space 24. In this case, as has already been explained, the movement of the piston 20 downward is limited by the projection 36 of the piston 20 stopping against the projection 38 of the housing lower part 12.

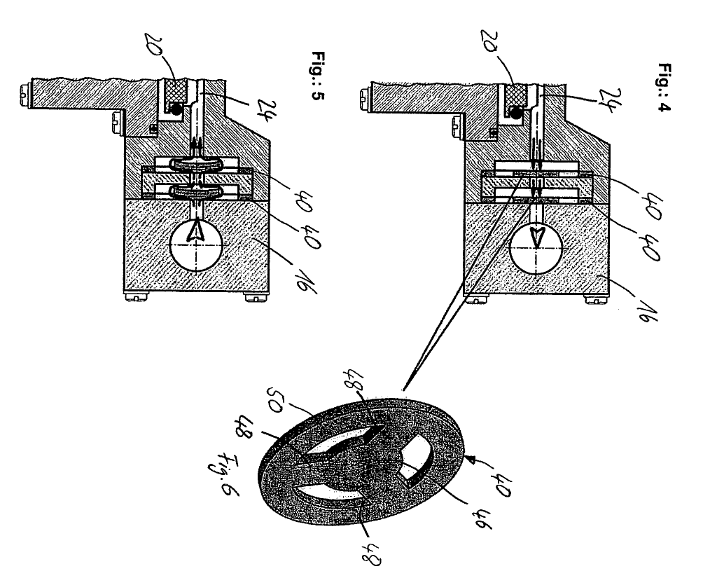

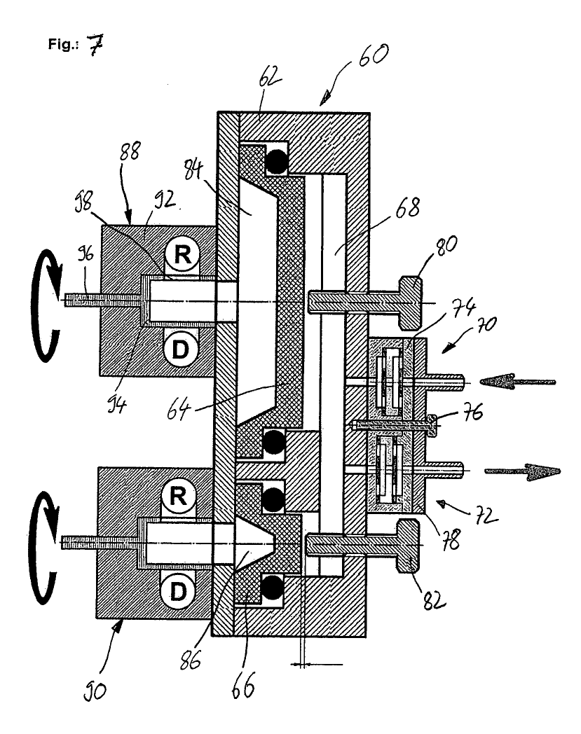

FIG. 4 and FIG. 5 illustrate the operation of the suction valve 26, with the outlet valve 28 operating in an analogous manner. In the illustration of FIG. 4, there is a higher pressure in the delivery space 24 than in the suction line in the suction flange 16. As a result of this, the two diaphragms 40 are pressed against the end surface of the intermediate part 42 and against the end surface of the suction flange 16. The positive pressure which originates from the delivery space 24 and presses the diaphragms 40 against the respectively associated end surfaces is clarified in the illustration of FIG. 4 by double arrows. As a result of this, the diaphragms 40 close the central through-bore arranged in the respective end surface.

If, by contrast, owing to the piston 20 moving into its inoperative position and thus enlarging the volume of the delivery space 24, the pressure in the delivery space 24 drops below the pressure in the suction channel in the suction flange 16, the central regions of the diaphragms 40 are deflected toward the delivery space 24, to the left in the illustration of FIG. 5, and liquid can flow out of the suction channel of the suction flange 16 around the central regions of the diaphragms and into the delivery space 24. As soon as there is equal pressure in the delivery space 24 and in the suction channel of the suction flange 16, the membranes 40 will realign themselves in such a manner that they bear in a sheet-like manner against the respectively associated end surface. As soon as the pressure in the delivery space 24 then rises further, the central regions of the diaphragms 40 are pressed against the respective end surfaces and, as a result, reliably close the respectively associated through-opening in the end surfaces.

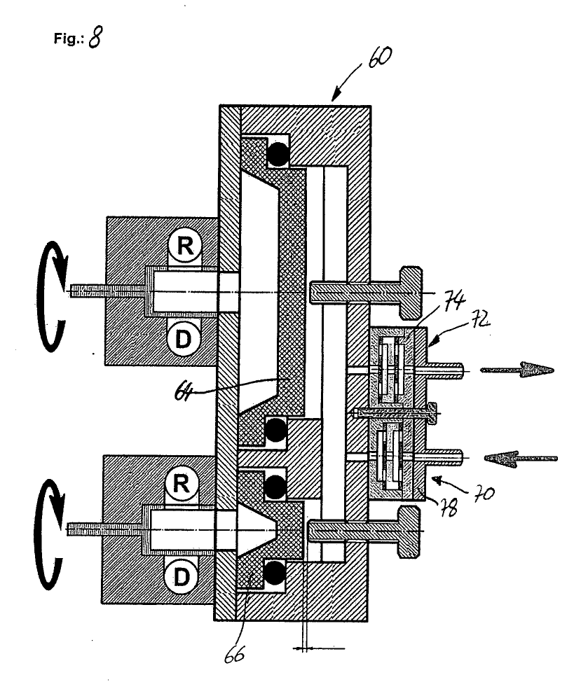

The illustration of FIG. 6 shows a diagraph 40 in a perspective illustration. The diaphragm 40 has a central region 46 which is of circular design and is connected to an outer ring 50 by means of three spoke-like connecting regions 48 spaced uniformly in the circumferential direction. By means of the point-symmetric design of the diaphragm 40, the latter is loaded uniformly, so that a very good sealing and a very long service life can be achieved. The diaphragm 40 is punched out of elastic sheet material, for example.

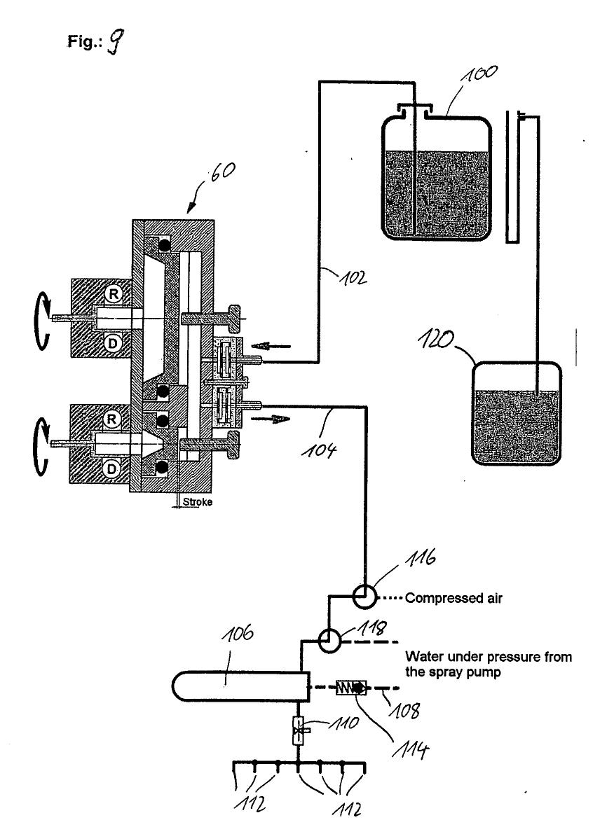

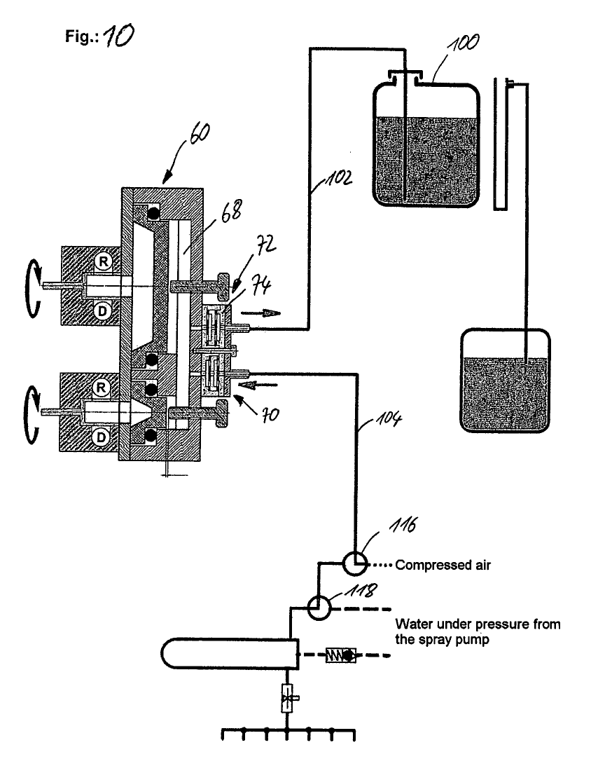

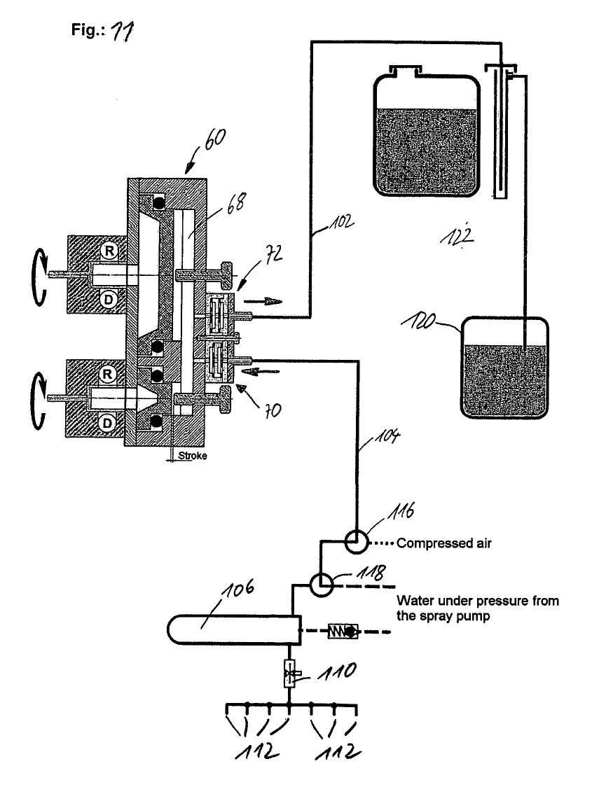

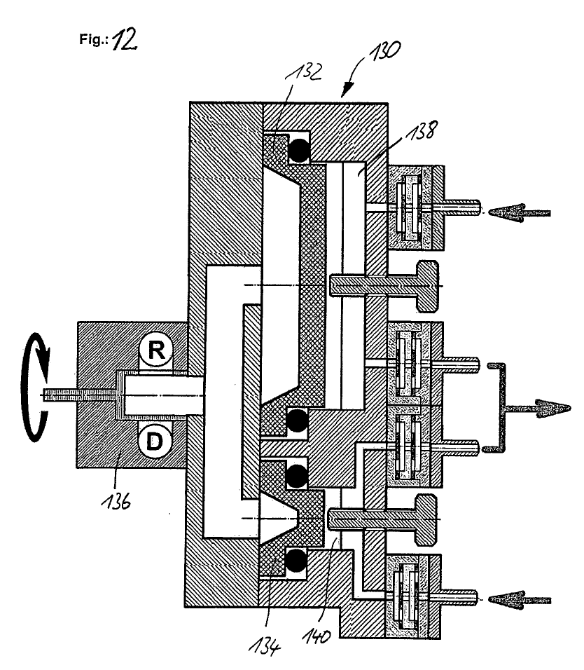

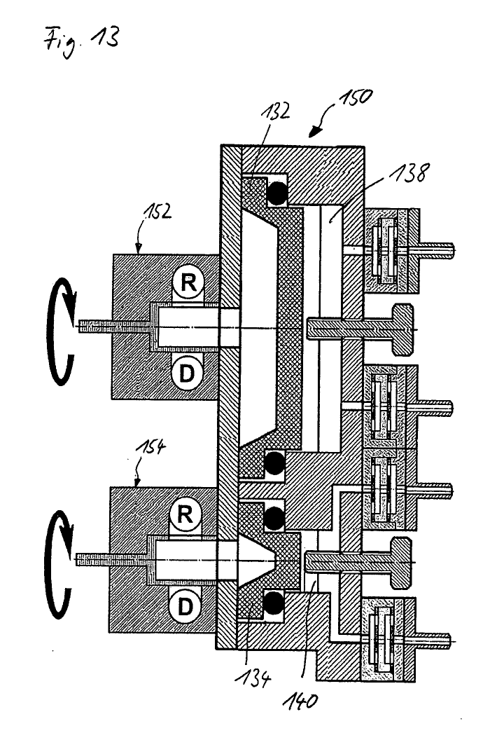

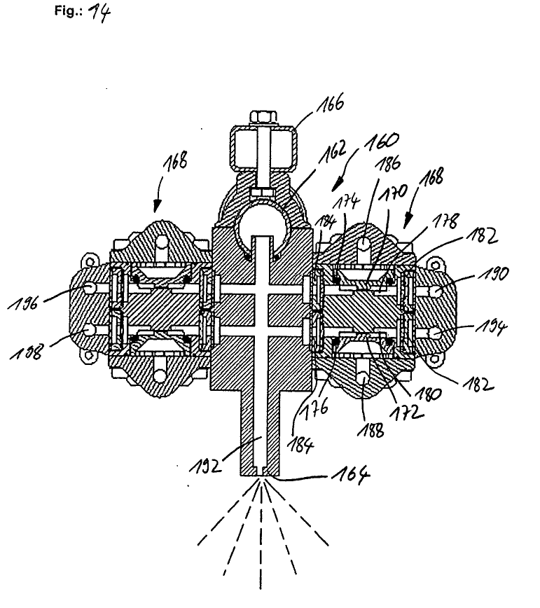

The illustration of FIG. 7 shows a metering pump 60 according to the second embodiment of the invention. The metering pump 60 has a housing 62 with a housing upper part and a housing lower part, in which two pistons 64 and 66 are displaceably mounted. In this case, the piston 64 has a significantly larger area than the piston 66, roughly four times the area. Each of the pistons 64, 66 is prestressed into its inoperative position by an elastic ring and, analogously to the metering pump 10 of FIG. 1, this elastic sealing ring also takes on a function of sealing off a delivery space 68 from the pistons 64, 66. The two pistons 64, 66 act upon the single delivery space 68. The delivery space 68 has a suction opening and an outlet opening which are respectively closed by a suction valve and an outlet valve. The suction valve and the outlet valve are of identical construction to the suction and outlet valves described in FIG. 1.

However, in contrast to the metering pump 10 of FIG. 1, the suction valve 70 and the outlet valve 72 are arranged in a common valve block 74. The valve block 74 is mounted rotatably relative to the housing 62 by means of a bolt 76 which passes through the valve block 74 and is screwed into an outer wall of the housing 62. The valve block 74 is arranged here between a flange component 78 with a suction pipe and an outlet pipe and an outer wall of the housing 62. The flange component 78 is likewise passed-through by the bolt 76 and is arranged immovable relative to the housing 62. The valve block 74 can therefore be rotated relative to the housing 62 and relative to the flange component 78. The suction valve 70 and the outlet valve 72 and especially the respectively associated through-bores are spaced apart here equally far from a central axis of the bolt 76 and lie, as can be seen in FIG. 7, in a common plane. The rotation of the valve block 74 through 1800 can therefore cause the outlet valve 72 to take up the space of the suction valve 70 and vice versa. This rotation of the valve block may take place manually or else by means of an electric motor.

Such a position of the valve block 74 in which it is rotated through 180° can be seen in the illustration of FIG. 8. As is indicated by arrows, the delivery direction of the metering pump 60 is reversed as a result, and the outlet pipe of FIG. 7 now serves according to FIG. 8 for sucking up liquid whereas the suction pipe of FIG. 7 operates according to FIG. 8 as an outlet pipe. In the case of a system according to the invention for the direct metering of active compounds, this reversal of the delivery direction is used to permit a recirculating operation and a flushing operation, as will be explained with reference to FIGS. 9, 10 and 11.

Threaded bolts 80, 82 protrude into the common delivery space 68, the threaded bolt 80 being arranged concentrically with a central axis of the larger piston 64 and the threaded bolt 82 being arranged concentrically with a central axis of the smaller piston 66. Those end surfaces of the threaded bolts 80 and 82 which face the piston 64 and 66, respectively, are used to define one of the two end positions of the pistons 64, 66 and therefore the working stroke of the pistons 64, 66. Accordingly, a working stroke of the piston 64 and 66 can be changed by screwing in or unscrewing the threaded bolts 80, 82. It is thereby possible to calibrate a delivery amount per stroke of the metering pump 60 and, in addition, it is also optionally possible, for example, to shut down one of the pistons 64, 66 by the threaded bolt 80 or 82 being screwed in to an extent sufficient for the particular piston 64 or 66 to be fixed in its inoperative position, which is illustrated in FIG. 7.

It can furthermore be seen in the illustration of FIG. 7 that the two pistons 64, 66 have separate pressure spaces 84 and 86, respectively. As a result, the pistons 64 and 66 can be acted upon in a different manner. The pressure space 84 here is acted upon by means of a first rotary control slide valve 88 and the pressure space 86 of the piston 66 is acted upon by means of a second rotary control slide valve 90.

The two rotary control slide valves 88, 90 are of identical construction, and so only the rotary control slide valve 88 is explained in more detail below. The rotary control slide valve 88 has a slide valve housing 92 in which a rotary slide valve 94 is rotatably mounted. The rotary slide valve 94 is driven by means of a shaft 96, for example by means of an electric stepping motor (not illustrated), the shaft 96 extending through an outer wall of the slide valve housing 92 and being accessible from the outside of the slide valve housing 92. At its end facing away from the shaft 96, the rotary slide valve 94 is of hollow-cylindrical design and has a control slot 98 in its circumferential wall. An end side of the rotary slide valve 94 that faces away from the shaft 96 is open, so that the pressure space 84 of the piston 64 and the interior of the hollow-cylindrical rotary slide valve 94 are always connected in terms of flow.

A pressure line T and a return line R are guided into the slide valve housing 92. There is a higher pressure in the pressure line D than in the return line R. When the rotary slide valve 94 is rotated about the shaft 96, in accordance with an annular arrow indicated in FIG. 7, the control slot 98 passes the mouth of the pressure line D, thus causing a pressure pulse in the interior of the rotary slide valve 94 and therefore also in the pressure space 84 of the piston 64. If the rotary slide valve 94 then continues to rotate, it passes the mouth of the return line R and, as a result, the pressure in the interior of the pressure space 84 of the piston 64 is reduced again and the hydraulic pause is ended. If a pressure pulse passes into the pressure space 84, the piston 64 will be displaced into the delivery space 68, to the right in the illustration of FIG. 7, until it strikes against the end surface of the rotary bolt 80. If the control slot 98 passes the mouth of the return line R, the pressure in the pressure space 84 is reduced and the piston 64 is pressed again by the prestressing force of the elastic ring into the position illustrated in FIG. 7.

The stepping motor for activating the rotary slide valve 94 is controlled here in such a manner that, in the inoperative position, the rotary slide valve 94 is always situated with the control slot 98 over the mouth of the return line R. This makes it possible for the leakage oils seeping through fitting points to be able to flow off without the risk of a build-up in pressure.

Among the advantages of the rotary control slide valve 88, 90 in comparison to a linear control slide valve are that a rotary control slide valve switches in neutral. This means that it does not switch counter to the pressure and does not switch with the pressure. As a result, the hydraulic pressure to be switched has only a very small influence on the mechanical resistance during switching. The rotary control slide valves 88, 90 can be used, as a result, also to switch high hydraulic pressures with little power consumption by the respectively assigned electric motors. It is precisely in the case of mobile applications, for example on a moveable field sprayer, that the maximum possible power consumption is severely limited by the power of the generators of the towing vehicle. In addition, at increasing switching frequency of a rotary control slide valve, the mechanical switching resistance increases only slightly because of the increased relative speed and the resultantly increased friction between the rotary slide valve and the housing. As a result, even high frequencies can be switched with only a low driving power being required. In addition, a rotary control slide valve operates only in one direction. By contrast, in the case of a linear control slide valve, a control element passes to and fro once during each pulse to be switched. As a result, during the change in direction, inertial forces of the switching element have to be overcome, so that additional electric power is required. With increasing switching frequency, these inertial forces to be overcome also considerably increase, so that a linear control slide requires considerable additional electric power as the switching frequencies increase. In addition, in the case of linear control slide valves which are usually equipped with a magnetic plunger drive, a restoring force has also to be applied in each working cycle, which means that the restoring spring which is always present has to be stressed at the same time. In contrast to this, a rotary control slide valve operates without a restoring force.

Provision of separate rotary control slides 88, 90 for the pistons 64, 66 makes it possible, for example, for only one of the two pistons 64, 66 to be operated so as to be able to vary a delivery amount per pulse of the metering pump 60.

In the illustration of FIG. 8, the metering pump 60 is illustrated with a reversed delivery direction. As can be seen, the valve block 74 has been rotated through 180°, so that liquid is now ejected through the suction pipe in the flange component 78 and liquid is sucked up through the outlet pipe of FIG. 7 in the flange component 78. Therefore, in comparison to the illustration of FIG. 7, only the suction valve 70 and the outlet valve 72 have changed positions. The reversal of the delivery direction is illustrated by correspondingly directed arrows in front of the connecting pipe of the flange component 78. In addition to a reversal of the delivery direction, the fact that the flow can pass through the metering pump 60 passively to its delivery direction is also of importance, as will be explained in conjunction with FIGS. 9, 10 and 11. Depending on the position of the valve block 74, liquid can therefore flow in two different directions through the metering pump 60 without the pistons 64, 66 moving out of their inoperative position.

The illustration of FIG. 9 diagrammatically illustrates a system for the direct metering of active compounds for agricultural technology with a metering pump as shown in FIGS. 7 and 8. The system illustrated diagrammatically in FIG. 9 constitutes a field sprayer, with the active compound, for example crop protection agents or liquid fertilizers, being sucked up from an active compound tank 100 via a first active compound line 102 by the metering pump 60. Starting from the metering pump 60, the active compound is then conveyed via a second active compound line 104 as far as a mixing chamber 106 where the active compound is then mixed with water under pressure from a spray pump from a first carrier liquid line 108. After mixing, the mixture of carrier liquid and active compound then passes into a throughflow meter 110 to the spray nozzles 102 of the field sprayer, which spray nozzles are arranged, for example, in one or more partial width sections. A nonreturn valve 114 is arranged upstream of the mouth of the first carrier liquid line into the mixing chamber 106 in order to prevent carrier liquid which is contaminated with active compound from passing into the carrier liquid line 108.

According to the invention, the active compound is therefore not metered into the suction region of the spray pump, but rather counter to the customary spray pressure of at maximum 10 bar into the carrier liquid. As can be seen in FIG. 9, the mixing chamber 106 can therefore be arranged directly upstream of a branch into the individual partial width sections. As a result, the length of line which has to be covered by the mixture of carrier liquid and active compound as far as the spray nozzles is kept short in comparison to a direct metering system, in which metering takes place in the suction region of the spray pump. As a result, short reaction times can be obtained when changing the concentration of active compound.

In addition, the metering pump 60 according to the invention is able to solve the problem of covering the extremely wide range of metered portions of the different active compounds in crop protection. Thus, metering amounts are usually specified in liters per hectare, and the metered portions which are to be covered cover a range of from 200 ml per hectare to 6 l per hectare. In addition, the working widths of customary field sprayers vary greatly, for example use is currently made of field sprayers with working widths of 12 m to 36 m. In addition, the metered portion also has to be matched to the traveling speed of the field sprayer, which is usually between 2 km/h and 15 km/h.

Since the pressure ring pump 60, that has already been described in conjunction with FIG. 7 and FIG. 8, has two pistons of different size which can be activated separately by means of a separate rotary control slide valve, a very wide range of metered portions can be covered. In addition, as has likewise already been explained, the working stroke of the two pistons can be set in each case via a threaded bolt. As a result, the delivery amount of the metering pump 60 per pressure pulse can be set within wide limits and can thus be set to the required metering amount and the working width of the field sprayer. It is to be emphasized here that the changing of the working stroke by the two threaded bolts can also, of course, take place variably by the threaded bolts being screwed or unscrewed by means of an electric motor.

The metering pump 60 and the stepping motors which drive the rotary slide valves of the rotary control slide valves are activated here by an electronic control system which, depending on the required amount of active compound, activates both pistons or just the large or small piston and at a different working frequency, if appropriate. Thus, with low metering amounts being required, only the small piston plate will operate and, in the normal range, only the large piston plate will operate and, with high metering amounts being required, both pistons will operate. All that the controller has to do for this is to recognize the delivery amount per pulse of each of the two pistons, which is easily achievable, for example by means of a calibration. The amounts of active compound to be delivered are then calculated by the electronic system and defined in pulses. The calculation is based on the measuring signals of the throughflow meter 110, which is present in any case on each field sprayer and supplies the signals for the pressure regulation of the spray pump. This throughflow meter 110 measures the amount of liquid flowing to the nozzles. In addition to the amount of water which is to be applied per hectare and which would also have already been input in the case of conventional field sprayers for the pressure regulation, an operator of the field sprayer inputs the amounts of active compound which are to be applied per hectare. With reference to the input desired value of the amount of water per hectare and the measured traveling speed, the pressure regulation then controls the spray pressure with the aim of achieving the desired value in liters of water per hectare. The activation of the metering pump 60 then has the task of calculating, with reference to the amount of water measured by means of the throughflow meter 110 and being applied at a particular instance and with reference to the stored desired values for the amount of active compound per hectare, the amounts of active compound to be added at a particular instance. The amount of active compound to be added at a particular instant is converted by the controller into activation pulses and the electric motors for driving the rotary control slide valve are correspondingly activated. One pulse corresponds here to one revolution of the electric motors. The electric pulses are then converted by the rotary control slide valve into a hydraulic pulse which then acts upon the pistons of the metering pump 60, as a result of which, per pulse, a defined amount of active compound is metered into the carrier liquid counter to the spray pressure.

As can be gathered from the illustration of FIG. 9, the active compound tank 100 here may directly constitute the delivery drum. The second active compound line 104 passes through two switching valves 116 and 118, the operation of which will also be explained below. In the spraying operation according to FIG. 9, the switching valves 116, 118 are switched in such a manner that the second active compound line 104 leads to the mixing chamber 106.

Furthermore, FIG. 9 also illustrates a disposal container 120 for flushing mixture, the function of which container will also be explained below.

After the spraying operation is ended, it is necessary to clean the lines which have been contaminated with active compound, since the active compounds used are often very aggressive and cannot be left in the lines for a relatively long time. In the case of the system according to the invention, it is possible to convey the active compound, which is still present in concentrated form not mixed with carrier liquid in the first active compound line 102, in the working space of the metering pump 60 and in the second active compound line 104, back into the active compound tank 100. In this context, it is to be stressed that a delivery with the metering pump 60 would not be possible, since the metering pump 60 can only operate if its delivery space is completely filled with liquid. The metering pump 60 would therefore not be capable of emptying the second active compound line 104, the first active compound line 102 and their dedicated delivery space and pumping the product back into the active compound tank 100.

In order to set what is referred to as a recycling operation, the switching valve 116 is rotated into the position which is shown in FIG. 10 and in which the second active compound line 104 is connected to a compressed-air line. At the same time, the valve block 74 is rotated through 180°, so that the flow can pass passively through the metering pump 60 and counter to its delivery direction in the delivery operation according to FIG. 9. Compressed air therefore flows via the switching valve 116 into the second active compound line 104, presses the active compound situated therein through the valve 70 in the valve block into the working space 68 and through the valve 72 into the first active compound line 102 and back into the active compound tank 100. As a result, a substantial portion of the active compound can already be forced out of the active compound lines 102, 104 and the metering pump 60 and, in addition, is available again in concentrated form for the spraying operation. As a result, the system according to the invention permits an extremely economical handling of expensive active compounds in agricultural technology.

After the recirculation operation, a flushing operation can be set in the case of the system according to the invention in order also to flush out the last residues of active compound from the metering pump 60 and the active compound lines 102, 104. The flushing operation is illustrated diagrammatically in FIG. 11. As can be seen, that end of the first active compound line 102 which faces away from the metering pump 60 and is provided with a suction lance is taken out of the active compound tank 100 and inserted into a flushing station 122. The suction lance is inserted here tightly into the flushing station 122 via a cover. The suction lance may likewise be inserted into the flushing station 122 during transportation of the field sprayer. The flushing station 122 is connected via a line to the disposal container 120. For the flushing operation, the switching valve 116 is brought again into the position in which it leads through the second active compound line 104. However, the second switching valve 118 is switched over, so that that end of the second active compound line 104 which faces away from the metering pump 60 is supplied with water under pressure by the spray pump. As a result, water under pressure is conveyed by the spray pump through the switching valve 118, the switching valve 116, the second active compound line 104, the valve 70, the delivery space 68, the valve 72, the first active compound line 102, through the flushing station 122 and into the disposal container 120. As a result, the interior walls of the pipe lines, the interior of the metering pump 60, the valves 70, 72 and the suction lance are thoroughly flushed. All of the parts up to the switching valve 118 which have come into contact with active compound are thereby cleaned and the cleaning liquid is collected in the disposal container 120. The switching valve 118 can then be set in such a manner that also the mixing chamber 106, the throughflow meter 110 and the spray nozzles 102 are supplied with water under pressure by the spray pump and are flushed.

It is to be emphasized here that, in comparison to conventional field sprayers, the amount of contaminated flushing mixture obtained is substantially lower, since only the residual amounts still present after the recirculation operation have to be flushed out of the active compound lines and the metering pump 60. As a result, the disposal container 120, for example, does not need to be emptied after each flushing operation. An emptying of the disposal container is possible, for example in a conventional manner, by the content of the disposal container 120, optionally further diluted until it is rendered ineffective, being discharged during a flushing trip. For the sake of clarity, the connections required for this are not shown in the illustrations.

The illustration of FIG. 12 shows a sectional view of a third embodiment of a metering pump 130. The metering pump 130 has two pistons 132, 134 mounted movably in its housing, the piston 132 having a significantly larger cross-sectional area than the piston 134. The pressure spaces of the pistons 132, 134 are acted upon by means of a single rotary control slide valve 136. As a result, there are always identical ratios in the pressure spaces of the pistons 132, 134. However, in contrast to the metering pump 60 of FIG. 7, each piston 132, 134 has a dedicated delivery space 138, 140. The larger piston 132 thus acts upon the delivery space 138 and the smaller piston 134 upon the delivery space 140. Each delivery space 138 is connected to a suction valve and an outlet valve. In this manner, by means of an external connection (not illustrated in FIG. 12) of the metering pump 130, a delivery volume can be set within wide limits.

The illustration of FIG. 13 shows a sectional view of a fourth embodiment of a metering pump 150 according to the invention. The only difference of the metering pump 150 from the metering pump 130 illustrated in FIG. 12 is that each of the pistons 132, 134 has a separate pressure space. Each of the pistons 132, 134 also has a separate delivery space 138, 140 which are connected in each case to a suction valve and an outlet valve.

The pressure space of the larger piston 132 is acted upon by means of a first rotary control slide valve 152 and the pressure space of the smaller piston 134 is acted upon by means of a second rotary control slide valve 154. The metering pump 150 therefore has two pump parts which can be activated independently of each other, with a different volume being delivered per pressure pulse in accordance with the diameter of the pistons 132, 134. As a result, the metering pump 150 can be used universally as a mixing pump in order to deliver two liquids in an exactly predefined ratio to each other and, for example, in order to meter them into a mixing chamber. In this case, any desired mixing ratio can be produced by the fact that the rotary control slide valves 152, 154 are driven at a different rotational frequency.

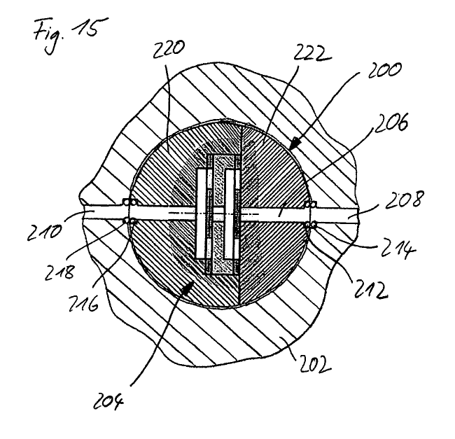

The illustration of FIG. 14 shows a sectional view of a nozzle holder 160 according to the invention for a field sprayer. The nozzle holder is fastened to a carrier liquid line 162 and surrounds the latter in the manner of a fastening clamp. As a result, carrier liquid from the carrier liquid line 162 can pass into the nozzle holder 160 and can be sprayed via a spray nozzle 164 arranged at the lower end of the nozzle holder 160. It is to be stressed here that the illustration of FIG. 14 is in the form of a diagram, since, for example, a drip stopping valve which is conventionally provided on nozzle holders is not illustrated. A linkage strut 166 of the field sprayer, which strut ensures that the linkage is sufficiently stabilized, runs parallel to the carrier liquid line 162. A respective metering pump block 168 is arranged on both sides of the nozzle holder. Both metering pump blocks 168 are of identical construction. Each metering pump block 168 has two pressure ring pumps which each have a piston 170 or 172. As in the case of the previously described embodiments of the pressure ring pump, the pistons 170, 172 are arranged displaceably in a pump housing and are prestressed into the position illustrated in FIG. 14 by means of respective elastic rings 174 and 176. Each piston 170, 172 is assigned a separate delivery space 178 and 180. Each delivery space 178, 180 is provided in each case with a suction valve 182 and an outlet valve 184. Each suction valve 182 comprises two diaphragm valves which are connected in series, as has already been explained, for example, with reference to FIG. 1. Each of the outlet valves 184 comprises two diaphragm valves which are connected in series, as has likewise already been explained with reference to FIG. 1. The piston plate 170 is acted upon via a hydraulic line 186 and the piston plate 172 is acted upon via a hydraulic pressure line 188. Hydraulic pulses are applied in the hydraulic pressure lines 186, 188, so that, as in the previously described embodiments, a delivery amount of the piston ring pumps can be defined in pulses. When the piston plate 170 moves, a first active compound is sucked into the delivery space 178 from a first active compound line 190 and correspondingly is added to the flow of carrier liquid through a central channel 192 of the nozzle holder 160. In an analogous manner, when the piston 172 moves, a second active compound is sucked into the delivery space 180 from a second active compound line 194 and is correspondingly injected into the central channel 192. A third active compound line 196 and a fourth active compound line 198 are guided into the opposite metering pump block 168. Each of the pressure ring pumps in the metering pump blocks 168 can be acted upon by means of a dedicated hydraulic line. Four different active compounds in different active compound concentrations can therefore be fed into the nozzle holder 160 illustrated in FIG. 14. It can be seen that, owing to the extremely short distance from the respective outlet valves 184 of the metering pumps to the central carrier liquid channel 192 of the nozzle holder 160, an imperceptible small reaction time can be achieved when changing the amount of active compound metered in in each case.

The illustration of FIG. 15 shows a sectional view of a valve block 200 for a metering pump according to the invention in accordance with a sixth embodiment. A valve block 200 has a cylindrical, roller-like form and is mounted rotatably about its longitudinal axis in a cylindrical bore of a housing 202. Arranged in the valve block 200 is a suction valve 204 and an outlet valve (which cannot be seen in FIG. 15). The suction valve 204 has two diaphragm valves connected in series and is constructed in an identical manner to the valves explained with reference to FIGS. 4 and 5. The diaphragm valves can shut off the flow through a central through-bore 206 of the valve block 200 or can open it up, the through-bore extending rectilinearly through the cylindrical valve block 200 and intersecting the central axis thereof. On opposite sides of the valve block 200 the through-bore 206 is aligned with an inlet bore 208 and an outlet bore 210. A transition between the through-bore 206 of the valve block 200 and the inlet bore 208 of the housing 202 is sealed off by means of a sealing ring 212 on the valve block side and a sealing ring 214 on the housing side. The sealing rings 212, 214 are respectively situated in a cylindrical recess in the valve block 200 and in the housing 202. In the same manner, a transition between the through-bore 206 of the valve block 200 and the outlet bore 210 is sealed off by means of a sealing ring 206 on the valve block side and a sealing ring 218 on the housing side. It can be gathered from the illustration of FIG. 15 that, in the case of a negative pressure in the inlet bore 210, liquid could flow through the suction valve 204 from the right to the left in the illustration of FIG. 15. The outlet valve (which cannot be seen in FIG. 15) is constructed analogously to the suction valve 204, but is rotated through 180° in comparison thereto, so that a throughflow direction from the left to the right in FIG. 15 would be achieved.

As can be gathered from FIG. 15, a pass-through direction of the suction valve 204 can be reversed in a simple manner by the valve block 200 being rotated through 180° in the housing 202. In this arrangement rotated through 180°, a throughflow direction through the suction valve 204 from the inlet bore 210 to the outlet bore 208 would then be provided. Upon a rotation of the valve block 200 through 180°, the outlet valve (not illustrated in FIG. 15) would be rotated at the same time through 180°. With a rotation of the valve block 200, it is possible as a result to reverse a delivery direction of a metering pump according to the invention in a simple manner, as has already been explained with reference to FIGS. 7 and 8.

The valve block 200 is constructed in two parts from a first cylinder section 220 and a second cylinder section 222. A separating plane between the first cylinder section 220 and the second cylinder section 222 runs parallel to a longitudinal axis of the valve block 200. This two-part division of the valve block 200 enables the suction valve 204 and the outlet valve (not illustrated) to be fitted in the valve block 200 in a simple manner. After the suction valve 204 and the outlet valve are fitted in the first cylinder section 220, the second cylinder section 222 is placed on and the thus completed valve block is then pushed into the bore of the housing 202.

1. A metering pump for the direct metering of active compounds, in particular for agricultural technology, having at least one housing with a delivery space, a reciprocating element, which bounds the delivery space at least on one side and is arranged movably in the housing, at least one suction valve connected in terms of flow to the delivery space, and at least one outlet valve connected in terms of flow to the delivery space, wherein the reciprocating element is designed as a piston which can be displaced between two end positions, and an elastic ring is provided between housing and piston, the elastic ring being at least partially compressed in both end positions of the piston.

2. The metering pump as claimed in claim 1, wherein each of the two end positions of the piston is defined by a particular stop surface of the piston bearing against the housing.

3. The metering pump as claimed in claim 1, wherein the elastic ring is arranged between a peripheral surface on the piston arranged essentially perpendicular to a direction of movement of the piston and a peripheral surface on the housing arranged essentially perpendicular to the direction of movement of the piston, the elastic ring prestressing the piston into one of its end positions and bringing about a seal between delivery space and piston.

4. The metering pump as claimed in claim 1, wherein the housing has an adjustable stop in order to variably limit a working stroke of the piston.

5. The metering pump as claimed in claim 1, wherein means for reversing a delivery direction are provided.

6. The metering pump as claimed in claim 5, wherein the suction valve and the outlet valve are arranged in a common valve block, the valve block being arranged rotatably relative to the housing of the metering pump.

7. The metering pump as claimed in claim 5, wherein a flange component with the suction pipe and the outlet pipe is provided, the suction valve and the outlet valve being arranged rotatably relative to the flange component.

8. The metering pump as claimed in claim 1, wherein the at least one suction valve and/or the at least one outlet valve in each case have at least one elastic diaphragm as shut-off element.

9. The metering pump as claimed in claim 8, wherein the suction valve and/or the outlet valve have a valve housing with a valve chamber, the valve chamber having an end surface with a passage bore arranged essentially centrally in the end surface, the elastic diaphragm, in the inoperative state, bearing at least in some sections against the end surface and having a central region which covers the passage bore and is connected by means of at least two spoke-like connecting regions to an outer ring of the elastic diaphragm.

10. The metering pump as claimed in claim 9, wherein three spoke-like connecting regions which are spaced uniformly from one another in the circumferential direction are provided.

11. The metering pump as claimed in claim 8, wherein the suction valve and/or the outlet valve has two diaphragm valves connected in series.

12. The metering pump as claimed in claim 1, wherein a pressure space which can be charged hydraulically is provided on a side of the piston that faces away from the delivery space.

13. The metering pump as claimed in claim 12, wherein a rotary control slide valve is provided for the hydraulic charging of the pressure space.

14. The metering pump as claimed in claim 13, wherein the rotary control slide valve has a slide valve housing and a rotary slide valve mounted rotatably in the slide valve housing, the slide valve housing being connected in terms of flow to a pressure supply line (D), a pressure removal line (R) and the pressure space.

15. The metering pump as claimed in claim 14, wherein the rotary slide valve is of hollow-cylindrical design and at least one control slot is provided in a circumferential wall of the rotary slide valve.

16. The metering pump as claimed in claim 1, wherein at least two displaceably arranged pistons are provided in the pump housing.

17. The metering pump as claimed in claim 16, wherein at least some of the pistons have a different cross-sectional area.

18. The metering pump as claimed in claim 16, wherein the pistons act upon a common delivery space.

19. The metering pump as claimed in claim 18, wherein means are provided in order to cause a different movement of the pistons.
and at least some of the pistons can be acted upon by different rotary control slide valves.

21. The metering pump as claimed in claim 16, wherein at least some of the pistons act upon a separate delivery space.

22. The metering pump as claimed in claim 21, wherein at least some of the pistons can be acted upon by means of a common rotary control slide valve.

23. A nozzle holder for agricultural spraying devices, comprising a metering pump as claimed in claim 1.

24. A system for the direct metering of active compounds for agricultural technology, comprising at least one metering pump as claimed in claim 1.

25. The system for the direct metering as claimed in claim 24, comprising at least one metering pump, at least one active compound tank with active compound which is to be metered, a carrier liquid tank and a carrier liquid pump and at least one partial width section with at least one spray nozzle, a first active compound line leading from the active compound tank to the suction connection of the metering pump and a second active compound line opening into a mixing chamber, a carrier liquid line leading from the carrier liquid tank via the carrier liquid pump to the mixing chamber, and a connection being provided between an outlet connection of the metering pump and upstream of the mixing chamber, for introducing compressed air into the second active compound line for a recirculating operation.

26. A system for the direct metering as claimed in claim 24, comprising at least one metering pump, at least one active compound tank with active compound which is to be metered, a carrier liquid tank and a carrier liquid pump and at least one partial width section with at least one spray nozzle, a first active compound line leading from the active compound tank to the suction connection of the metering pump and a second active compound line opening into a mixing chamber, a carrier liquid line leading from the carrier liquid tank via the carrier liquid pump to the mixing chamber, and a connection being provided between the outlet connection of the metering pump and upstream of the spray nozzles, for introducing carrier liquid into the second active compound line for a flushing operation.

27. A system for the direct metering as claimed in claim 26, wherein a disposal container for receiving a mixture of carrier liquid and active compound, in particular from a flushing operation, is provided, and during the flushing operation the first active compound line can be switched over from the active compound tank to the disposal container.
